(19) United States
(12) Patent Application Publication
(10) Pub. No.: US 2022/0241875 A1
(43) Pub. Date: Aug. 4, 2022

(54) TOOL PART AND METHOD FOR PRODUCING A TOOL PART OF THIS KIND

(71) Applicant: MAPAL Fabrik für Präzisionswerkzeuge Dr. Kress KG, Aalen (DE)

(72) Inventor: Oliver Pecat, Aalen (DE)

(21) Appl. No.: 17/725,159

(22) Filed: Apr. 20, 2022

Related U.S. Application Data
(63) Continuation of application No. PCT/EP2020/079517, filed on Oct. 20, 2020.

(30) Foreign Application Priority Data
Oct. 21, 2019 (DE) 10 2019 216 199.5

(51) Int. Cl. B23C 5/16; B23B 51/02; B23P 15/32

(52) U.S. Cl. CPC B23C 5/16; B23B 51/02; B23C 2228/10; B23B 2228/10; B23P 15/32

(57) ABSTRACT

The invention relates to a tool part (1) having a main body (3) and at least one cutting zone (5) formed on the main body (3), wherein the cutting zone (5) has a clearance face (7) and a rake face (9) which adjoin each other at a cutting edge (11), wherein the rake face (9) has a coating (13) applied to a main body material of the main body (3) and extending as far as the cutting edge (11), which coating is harder than the main body material. According to the invention, the clearance face (7) is free of the coating (13) in a clearance zone (15) proceeding from the cutting edge (11).

### CROSS REFERENCE TO RELATED APPLICATIONS

This application is a continuation of International Application Number PCT/EP2020/079517, filed Oct. 20, 2020, which claims the benefit of German Application Number 10 2019 216 199.5, filed Oct. 21, 2019, the content of each of which is incorporated herein by reference in its entirety.

### FIELD OF THE INVENTION

The invention relates to a tool part and to a method for producing a tool part of this kind.

A tool part of this kind has a main body and at least one cutting zone formed on the main body. The cutting zone has a clearance face and a rake face, the clearance face and the rake face adjoining each other at a cutting edge.

In the case of a tool part of this kind, there is generally the problem of wear during the machining of workpieces. In particular, it is possible for the clearance face and/or the rake face to be damaged or removed in certain zones, with the cutting edge becoming blunt.

In order to reduce wear, the cutting zone is provided with a coating that increases the wear resistance of the tool part. Although this can delay wear, the wear behavior is often unsatisfactory, in particular when machining abrasive materials such as fiber-reinforced plastics or aluminum alloys. Although delayed, rounding of the cutting edge still occurs, which cutting edge thereby becomes blunt, increasing cutting pressure and increasing stress on the cutting edge and coating. Partial failure of the coating can occur, which coating then flakes off, exposing the underlying material directly to the abrasive workpiece. Once damage of this kind is present, the wear of the tool part progresses very rapidly until the cutting edge fails.

### SUMMARY

The invention is based on the object of creating a tool part and a method for producing a tool part of this kind, the disadvantages mentioned being at least reduced and preferably not occurring.

The object is achieved by the provision of the present technical teaching, in particular the teaching of the independent claims and the embodiments disclosed in the dependent claims and the description.

The object is achieved in particular by creating a tool part in which the rake face has the coating applied to a main body material of the main body, the coating extending as far as the cutting edge and being harder than the main body material. According to the invention, it is provided that the clearance face, proceeding from the cutting edge, is free of the coating in a clearance zone. As a result, the clearance face in the clearance zone, which directly adjoins the cutting edge, has a different, in particular lower, hardness than the rake face in which the coating extends as far as the cutting edge. Thus far, it has been recognized that the remaining wear in a conventional tool part despite a wear-resistant coating is based in particular on the clearance face and the rake face wearing relatively evenly, which ultimately results in the rounding of the cutting edge and thus it becoming blunt. According to the invention, it has now been recognized that this wear mechanism can be overcome in that the wear properties of the rake face on the one hand and the clearance face on the other are formed differently in a targeted manner. In particular, the clearance face in the clearance zone wears faster than the rake face due to the lack of a coating there, so that the cutting edge in the zone of the clearance face is gradually less supported by material and ultimately breaks off. This creates a new breaking edge, which in turn is sharp, so that the cutting edge remains unrounded and sharp. The breaking that occurs in this way or the depth of the material removed extends in the range from a maximum of 0.1 mm to a few hundredths of a millimeter, preferably a few micrometers, so that no relevant change in geometry occurs in the cutting zone. Rather, the cutting edge remains defined. The coating which extends on the rake face as far as the cutting edge, but which coating is left out in the clearance zone of the clearance face directly adjacent to the cutting edge, results in a self-sharpening effect for the tool part, which improves the wear behavior and increases the service life of the tool part.

A tool part is understood to mean in particular a tool, in particular a cutting tool, or a part of a tool or for a tool, in particular a part of a cutting tool or for a cutting tool, in particular a cutting plate, in particular an indexable cutting plate.

The cutting edge is in particular a geometrically defined cutting blade. The fact that the clearance face and the rake face adjoin each another in the cutting edge means in particular that they meet in the cutting edge. This in turn means in particular that the cutting edge represents a line of intersection of the clearance face with the rake face. The clearance face and the rake face are oriented obliquely to one another, i.e. they form an angle with one another that differs from 0° on the one hand and from 180° on the other, so that they intersect, with the line of intersection forming the cutting edge.

The fact that the coating is harder than the main body material means in particular that the coating has a greater hardness than the main body material. The hardness can be given, for example, as universal hardness or Martens hardness, Brinell hardness, as Vickers hardness, as Rockwell hardness, or as Mohs hardness; it is only important that the same hardness scale is used for the main body material and the coating.

In a preferred embodiment, the main body material has hard metal or consists of hard metal; or the main body material has high-speed steel, also referred to as HSS, or consists of high-speed steel. Alternatively or additionally, the coating is a hard material layer, in particular a diamond coating.

The fact that the clearance face is free of the coating in a clearance zone proceeding from the cutting edge means in particular that the clearance face is free of the coating at least in certain zones, namely at least in the clearance zone that directly adjoins the cutting edge. The clearance zone extends, in particular, over a specific extension zone perpendicular to the cutting edge. In particular, the clearance zone also extends at least over a specific zone along the cutting edge.

According to one embodiment, it is possible for the clearance zone to extend completely over the clearance face, so that in particular the entire clearance face is free of the coating. Alternatively or additionally, it is possible for the clearance zone to extend along the entire cutting edge.

The fact that the clearance face in the clearance zone is free of the coating means in particular that the clearance face does not have the coating in the clearance zone. The clearance face in the clearance zone preferably has no coating. In particular, the clearance face is preferably uncoated in the clearance zone.

The clearance zone preferably has a width of at least 0.2 mm to at most 0.7 mm, preferably at least 0.3 mm to at most 0.6 mm—measured contrary to a cutting direction proceeding from the cutting edge, in particular measured perpendicularly to the cutting edge. If the tool part is designed as a cutting tool, in particular as a drill or milling cutter, the clearance zone has the corresponding width, preferably at least in the zone of a cutting corner of the cutting tool.

A clearance angle of the cutting zone, measured in particular perpendicularly to the cutting edge, is preferably from at least −3° to at most +6°, preferably from at least −2° to at most +5°, preferably from at least −1° to at most +4°, preferably from at least 0° to at most +3°, preferably from at least +1° to at most +2°. These value ranges for the clearance angle apply in particular to the cutting zone of a tool part which is designed as a drilling tool, in particular as a drill, and has a point angle of 90°.

A rake angle of the cutting zone is preferably at most 30°, preferably less than 30°, preferably from at least 25° to at most 30°. These value ranges have proven to be particularly favorable for the adhesion of the coating on the rake face of the tool part.

If the tool part is designed as a drilling tool, in particular a drill, it preferably has a helix angle of less than 30°, preferably at most 30°, preferably at least 25° to at most 30°.

The coating preferably has a thickness of at least 4 μm to at most 15 μm, preferably at least 5 μm to at most 12 μm, preferably at least 6 μm to at most 10 μm, preferably at least 7 μm to at most 9 μm, preferably a thickness of 8 μm.

According to a development of the invention, it is provided that the main body material is exposed or uncovered in the clearance zone. This means in particular that the main body material forms a surface of the clearance face. In this case in particular, it is ensured that the clearance face in the clearance zone wears out faster than the rake face. In particular, during the machining of a workpiece, the main body material in the clearance zone faces the workpiece material and is in direct contact with the workpiece material. As a result, it is directly affected by the particularly abrasive workpiece material.

According to a development of the invention, it is provided that—viewed contrary to the cutting direction of the tool part—a coating zone of the clearance face adjoins the clearance zone, with the clearance face having the coating in the coating zone. In this case, the clearance face is accordingly not entirely free of the coating, but only in certain zones, namely in the clearance zone comprising only part of the clearance face. Thus, in an advantageous manner, the wear of the clearance face is only increased in the clearance zone in comparison to the rake face.

A cutting direction is understood in this case as an imaginary direction along which the cutting edge is intended to be moved relative to the workpiece when machining a workpiece. The cutting direction is preferably oriented obliquely to the cutting edge; in particular, it is possible for the cutting direction to be perpendicular to the cutting edge.

According to a development of the invention, it is provided that the clearance zone extends along the cutting edge only over a clearance length that is shorter than a cutting length of the cutting edge. In this case, therefore, the clearance zone does not extend along the entire cutting edge, but only in certain zones over the clearance length. Accordingly, the self-sharpening effect of the cutting edge only occurs in the zone of the clearance length.

The cutting length of the cutting edge is in particular the length of that extension of the cutting edge along which it is sharpened. Preferably the cutting length is the total length of the cutting edge.

A step is formed where the clearance zone along the cutting edge ends, since the coating adjacent to the clearance length has a finite thickness. This step is itself sharp and therefore has cutting properties. It is therefore also referred to as the cutting step. In particular when machining fiber-reinforced materials, this has the additional advantage that fibers which have not yet been cut by the cutting edge and which reach the zone of the cutting step are cut by the latter.

The cutting step is preferably only a few tenths of a millimeter high. In this respect, it is particularly possible that, when removing the coating, main body material is also removed in addition to the coating, so that the result may be that the cutting step is higher than the height of the coating above the main body material.

In particular, fibers protruding at the edge of a bore are often not cleanly cut off by conventional tool parts designed as a drilling tool or cutting plate for a drilling tool, so that the edge of the bore is frayed. Fibers of this kind are now cut off by the cutting step when the tool part emerges from the workpiece. In particular, when the center of the tool part emerges from the material of the machined workpiece, fibers are bent away and not cut, because, in the zone of the center, the cutting speed is low on the one hand and the rake angle is comparatively small on the other hand, so that the cutting edge is not very easy to cut. The bent, resilient fibers yield and slide along the cutting edge without being cut. However, the fibers are now cut off by the cutting step when they slide along the cutting edge and hit against the cutting step.

According to a development of the invention, it is provided that the tool part is designed as a cutting tool, in particular as a drilling tool, in particular as a drill, in particular for abrasive materials. The cutting edge is in particular a front cutting blade of the drill, i.e. a cutting blade arranged on the front side of the drill, in particular a main cutting blade. In the case of a drill of this kind, the advantages already described above are realized in a special way.

The tool part, in particular a drilling tool, preferably has two cutting zones of the type described above. In this case, the tool part is designed having two cutting edges. It is possible that the tool part has more than two cutting zones of this kind.

A flute is preferably assigned to the at least one cutting zone, with the rake face preferably forming a boundary wall of the flute or being formed by a boundary wall of the flute. In a particularly preferred embodiment, the drill is a helical drill, in which case it has at least one helical flute.

According to a development of the invention, it is provided that the tool part is designed as a cutting tool, in particular as a milling tool, in particular as a milling cutter, in particular for abrasive materials. In this case, the cutting edge is preferably a peripheral cutting blade of the milling tool, in particular of the milling cutter.

According to a development of the invention, it is provided—in particular in the case of a tool part designed as a drilling tool, in particular a drill, but not limited to this—that the clearance zone extends radially inward, proceeding from a cutting corner of the cutting edge, only along part of the cutting edge. An axial direction extends in this case in particular along an imaginary axis of rotation or central axis of the cutting tool, in particular of the drilling tool. A radial direction is perpendicular to the axial direction, and a circumferential direction concentrically encompasses the axial direction. “Radially inward” means an orientation or extension toward the central axis.

The cutting corner is in particular a radially outermost point of the cutting edge; in particular, the cutting corner defines a cutting circle of the cutting edge. In particular, the cutting edge at the cutting corner merges into a peripheral or secondary cutting edge of the cutting tool. The clearance zone is therefore provided in particular radially on the outside of the cutting edge, in which case it does not completely extend as far as a radially inner end of the cutting edge, but rather it extends only over said part. This part of the cutting edge is in particular the previously defined clearance length. In addition, the clearance face outside the clearance length toward the central axis is provided with the coating. The axial cutting step already described above thus results in the transition zone between the clearance length of the cutting edge and the coated part. The clearance zone and in particular the clearance length is preferably dimensioned in such a way that there is homogeneous wear across the clearance zone along the cutting edge. Since the cutting speed and the cutting volume vary, in particular decrease, from the radially outer cutting corner to the radially inner end of the cutting edge, the wear also varies accordingly, with it decreasing sharply in particular toward the central axis. The coating can thus be retained in the radially inner zone, and homogeneous wear is achieved by excluding this radially inner zone of the cutting edge from the clearance zone. In particular, it has been shown that, on the one hand, it would be expensive and complicated to also remove the coating in the radially inner zone, while, on the other hand, the cutting speed continues to decrease toward the central axis, so that the self-sharpening effect would occur less or no longer.

According to a development of the invention, it is provided that the cutting edge has a central cutting blade and a main cutting blade, with the clearance zone extending only along the main cutting blade. The coating can remain in place in particular in the zone of the central cutting blade, since there is no longer any great wear due to the reduced cutting speed, and removing the coating would also be expensive and complicated.

The clearance zone preferably only extends in certain zones along the main cutting blade, in particular proceeding from the cutting corner not all the way to the central cutting blade. Rather, the clearance zone ends—along the cutting edge—at a radial distance from the central cutting blade. In this way in particular, wear that is as homogeneous as possible can be ensured over the clearance zone along the cutting edge.

The central cutting blade is preferably provided by thinning in a manner known per se.

Overall, the cutting zone of the cutting tool, in particular the drilling tool, preferably has a crosscutting blade in a manner known per se, preferably viewed radially outward from the central axis, followed by the adjacent central cutting blade and then the adjacent main cutting blade.

According to a development of the invention, it is provided that the tool part is designed as a cutting plate, in particular as an indexable cutting plate, in particular for abrasive materials. The advantages already mentioned above are also realized with a tool part of this kind.

An abrasive material is understood to mean, in particular, a material that is subject to wear and tear in comparison with other materials, which in this respect causes increased wear of the tool part or places a higher load on the tool part during its machining. In particular, an abrasive material is a fiber-reinforced plastics material, in particular a carbon-fiber-reinforced plastics material (CFRP). Fiber-reinforced materials of this kind have a highly abrasive effect. Alternatively, the abrasive material is an aluminum alloy, in particular an aluminum cast material, in particular an aluminum-silicon alloy. The advantages of the tool part are realized in a special way, in particular when machining abrasive materials.

The object is also achieved by creating a method for producing a tool part, in particular a tool part according to the invention or a tool part according to one of the embodiments described above, the method having the following steps: A cutting zone formed on a main body for the tool part, which has a clearance face and a rake face, the clearance face and the rake face adjoining each other at a cutting edge, is coated with a coating that is harder than a main body material of the main body. The coating is removed at least in certain zones on the clearance face. In particular, the coating is removed from the clearance face at least in certain zones. In particular, a clearance zone that is free of the coating is formed on the clearance face. In particular, the coating is removed at least in certain zones in such a way that the clearance zone is formed on the clearance face. In particular, a tool part is obtained in this way, in particular a tool part according to the invention or a tool part according to one of the embodiments described above. In connection with the method, the advantages already explained in connection with the tool part are realized in particular.

As part of the method, a cutting tool, in particular a drilling tool, in particular a drill, a milling tool, or a cutting plate, in particular for machining abrasive materials such as fiber-reinforced materials or aluminum alloys, in particular for machining carbon-fiber-reinforced plastics, is preferably produced as the tool part.

The cutting zone is coated in particular with a hard material layer, preferably with a diamond layer.

The cutting zone is preferably completely coated. In particular, the clearance face is completely coated. The cutting zone, including at least one flute, is particularly preferably completely coated.

In a preferred embodiment, in the case of a tool part designed as a cutting tool, the main body has a working portion and an adjacent fastening portion or rake portion. The working portion has the at least one cutting zone. The fastening portion is set up to clamp the cutting tool in a machining device, in particular a machine spindle, or to fasten it to a machining device. At least the working portion is preferably completely coated with the coating.

When removing the coating, the main body material of the main body is preferably uncovered, in particular exposed. The coating is therefore in particular completely removed in the clearance zone, so that the main body material is uncovered.

The coating is preferably removed by means of a laser method, in particular by a laser beam, in particular by a pulsed laser beam or by a continuous laser beam.

In addition to the self-sharpening effect, a very sharp cutting edge, in particular with a cutting edge roughness of less than 6 μm, is obtained from the start by removing the coating. As a result, a rounding of the cutting edges due to the otherwise relatively thick coating can be eliminated in a particularly advantageous manner. In particular, requirements for small cutting edge radii for the machining of fiber composite materials can be met. These advantages are realized in a special way when the coating is removed by means of a laser method.

According to a development of the invention, it is provided that—prior to coating—the cutting zone is produced, in particular formed, on the main body. The cutting zone is preferably formed on the main body by grinding the main body.

Prior to the production of the cutting zone, the main body is preferably provided. In particular, a hard metal rod or a hard metal plate is preferably provided as the main body. The main body preferably has hard metal as the main body material. However, the main body can also have a different material, in particular high-speed steel, in particular HSS. In particular, the main body can consist of one of the materials mentioned.

According to a development of the invention, it is provided that—prior to coating—a cutout is introduced into the clearance face at a distance from the cutting edge. In particular, this means that material is taken away or removed from the clearance face. The cutout is preferably formed as a depression, as an additional incline or bevel on the clearance face or in the zone of the clearance face, or as a step. The cutout preferably defines a boundary of the later clearance zone and advantageously facilitates the removal of the coating in the clearance zone by providing a defined boundary.

The fact that the cutout is introduced into the clearance face at a distance from the cutting edge means in particular that the clearance is at a distance from the cutting edge perpendicular to the cutting edge, in particular contrary to the cutting direction.

The coating is preferably only removed in the clearance zone which is delimited on the one hand by the cutting edge and on the other hand by the cutout. Thus, the geometric configuration and in particular the extension of the clearance zone is already defined prior to the removal of the coating, and it is possible to remove the coating in a particularly defined and simple manner, so that in particular the main body material is uncovered in the clearance zone.

The method proposed in this case can be carried out in a particularly simple and cost-effective manner, in particular since it does not require any selective coating of the main body; rather, it is initially completely coated at least in the cutting zone, with the coating being subsequently removed again in a defined manner in the clearance zone.

The clearance zone is preferably formed in the manner explained above in connection with the tool part.

The tool part preferably has the cutout which, according to the method step described above, is introduced into the clearance face at a distance from the cutting edge prior to coating. In the tool part proposed in this case, too, the clearance zone is preferably delimited on the one hand by the cutting edge and on the other hand by the cutout.

### BRIEF DESCRIPTION OF THE DRAWINGS

The invention is explained in greater detail below with reference to the drawing. In the drawing:

FIG. 1 is a perspective view of a first embodiment of a tool part;

FIG. 2 is a front plan view of the tool part according to FIG. 1;

FIG. 3 is a side view of the tool part according to FIGS. 1 and 2;

FIG. 4 is a perspective detailed view of a second embodiment of a tool part, and

FIG. 5 is a perspective view of a third embodiment of a tool part.

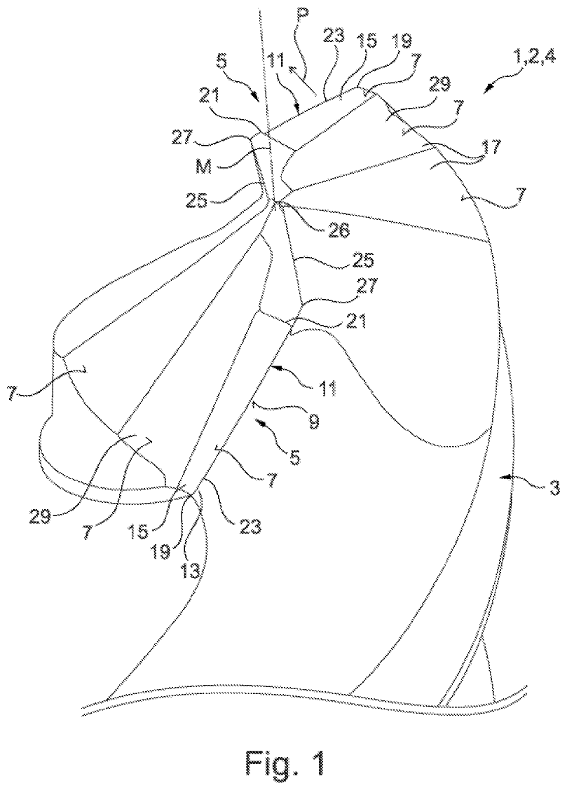

FIG. 1 is a view of a first embodiment of a tool part 1 which is designed in this case in a preferred embodiment as a cutting tool 2, in this case in particular as a drilling tool 4, in particular as a drill. The tool part 1 is set up in particular for machining abrasive workpieces, which preferably comprise fiber-reinforced plastics material or an aluminum alloy, in particular workpieces which comprise carbon-fiber-reinforced plastics material or carbon-fiber-reinforced plastics material.

The tool part 1 has a main body 3 having at least one cutting zone 5 formed on the main body 3, in this case exactly two cutting zones 5. The two cutting zones 5 are designed identically to one another, so that only one of the cutting zones 5 is explained in more detail below, it not being important which of these cutting zones 5 it is.

The cutting zone 5 comprises a clearance face 7 and a rake face 9 which adjoin each other at a cutting edge 11. The rake face 9 has a coating 13 which is applied to a main body material of the main body 3 and extends as far as the cutting edge 11 and is harder than the main body material. The main body material is preferably hard metal and the coating is a hard material layer, in particular a diamond layer.

Proceeding from the cutting edge 11, the clearance face 7 is free of the coating in a clearance zone 15. This advantageously provides different wear conditions when machining a workpiece for the clearance face 7 on the one hand and the rake face 9 on the other hand, with the clearance face 7 being removed more quickly. As a result, the cutting edge 11 loses mechanical support in the zone of the clearance face 7 and breaks off successively, becoming sharp again at the breaking edge, so that the tool part 1 advantageously has a self-sharpening effect. In this way, the wear of the tool part 1 can be reduced overall and its service life can be extended. This applies in particular to the machining of abrasive materials such as fiber-reinforced plastics material or aluminum alloys.

The main body material is preferably exposed or uncovered in the clearance zone 15.

To machine a workpiece, a relative rotation is preferably effected between the tool part 1 and the workpiece about a central axis M of the tool part 1, in this case counterclockwise according to FIG. 1, this defining a cutting direction for the cutting edge 11 indicated by an arrow P.

Contrary to the cutting direction, the clearance zone 15 is adjoined by a coating zone 17 in which the clearance face 7 has the coating.

It is clear from FIG. 1 that the cutting edge 11 is in particular a front cutting blade of the drill. It is also clear that the clearance zone 15 extends radially inward, proceeding from a cutting corner 19 of the cutting edge 11, i.e. toward the central axis M, only along part of the cutting edge 11. The clearance face 7 is coated along the remaining part. In the zone of the transition between the uncoated part, i.e. the clearance zone 15, and the coated part, an axial cutting step 21 is formed in particular, seen along the cutting edge 11. This embodiment has the particular advantage that when the tool part 1 passes through a workpiece made of fiber-reinforced plastics material, fibers protruding beyond the wall of a bore are reliably cut off by the sharp cutting step 21 while they slide along the cutting edge 11, where they finally land on the cutting step 21 and get cut there.

The cutting edge 11 is divided in particular into a main cutting blade 23, which is arranged radially on the outside and extends as far as the cutting corner 19, and a central cutting blade 25, which is produced in particular by sharpening the drill. The clearance zone 15 extends only along the main cutting blade 23, in particular—as can be seen in FIG. 1—only in certain zones along the main cutting blade 23, namely proceeding from the cutting corner 19 radially inward and not as far as a transition 27 into the central cutting blade 25. In this way in particular, homogeneous wear and thus homogeneous self-sharpening of the cutting edge 11 can be ensured.

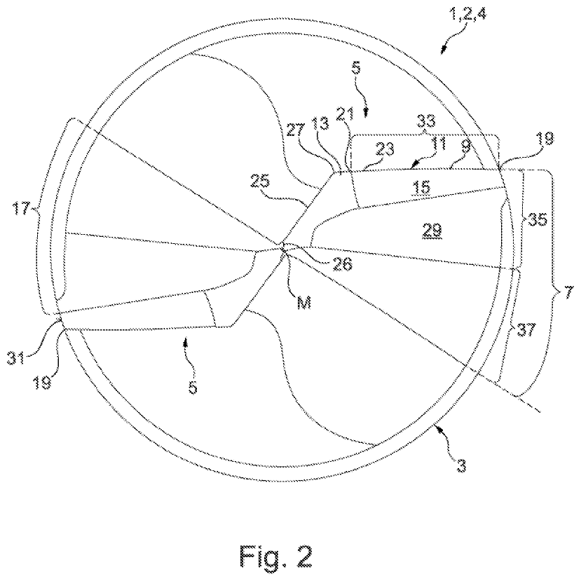

FIG. 2 is a plan view of a front side of the tool part 1 according to FIG. 1.

Identical and functionally identical elements are provided with the same reference numbers, so that in this respect reference is made to the preceding description.

For the sake of simplicity, the majority of the reference numbers are given in this case only on one of the cutting zones 5; the other cutting zone 5 is—as stated—designed to be identical. Again only for the sake of greater clarity, some reference numbers are only assigned to the other cutting zone 5.

FIG. 2 clearly shows the different cutting blade portions of the cutting zone 5, with a crosscutting blade 26, then the central cutting blade 25, and then the main cutting blade 23 being provided radially outward proceeding from the central axis M toward the cutting corner 19. A circular ground bevel 31 preferably adjoins the cutting corner 19 in the circumferential direction.

FIG. 2 also shows that the clearance zone 15 extends along the cutting edge 11 only over a clearance length 33 which is shorter than a cutting length, in particular than a total length, of the cutting edge 11.

FIG. 2 also shows that the clearance face 7 has a first clearance face portion 35 and a second clearance face portion 37, the first clearance face portion 35 comprising the clearance zone 15 and the cutout 29. The second clearance face zone 37 is arranged obliquely to the first clearance face zone 35, in particular to the cutout 29. The cutout 29, together with the second clearance face portion 37, forms the coating zone 17.

The cutting step 21 is also clearly visible in FIG. 2. In particular, the clearance length 33 extends between the cutting corner 19 on the one hand and the cutting step 21 on the other. In particular, the clearance length 33 is delimited by the cutting corner 19 on the one hand and the cutting step 21 on the other.

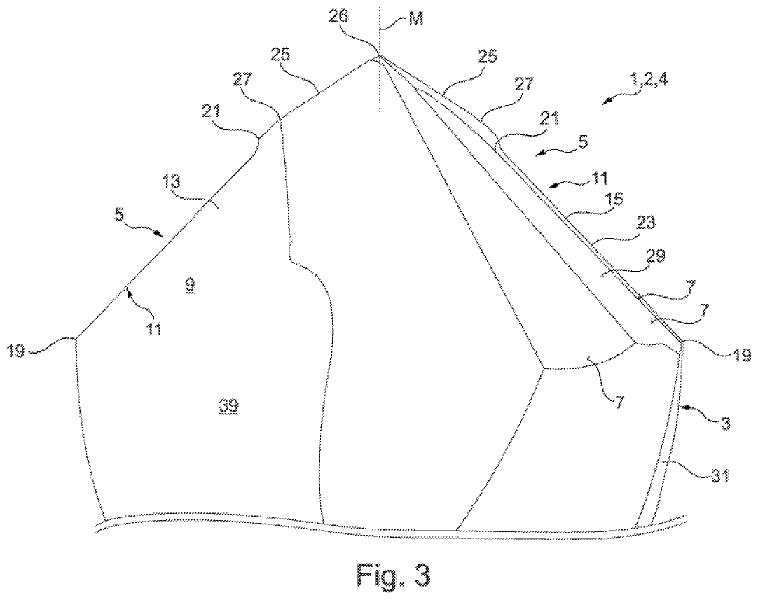

FIG. 3 is a side view of the tool part 1 according to FIGS. 1 and 2. The viewer's gaze in FIG. 3 falls on the rake face 9 in the left-hand cutting zone 5, which is concealed from the viewer in the right-hand cutting zone 5. In the right-hand cutting zone 5, the different portions of the clearance face 7 and in particular also the clearance zone 15 can be seen very well.

A flute 39 is preferably assigned to each of the cutting zones 5, the rake face 9 also being a wall of the flute 39. The drill shown in this case is in particular a helical drill, with the flutes 39 being helical.

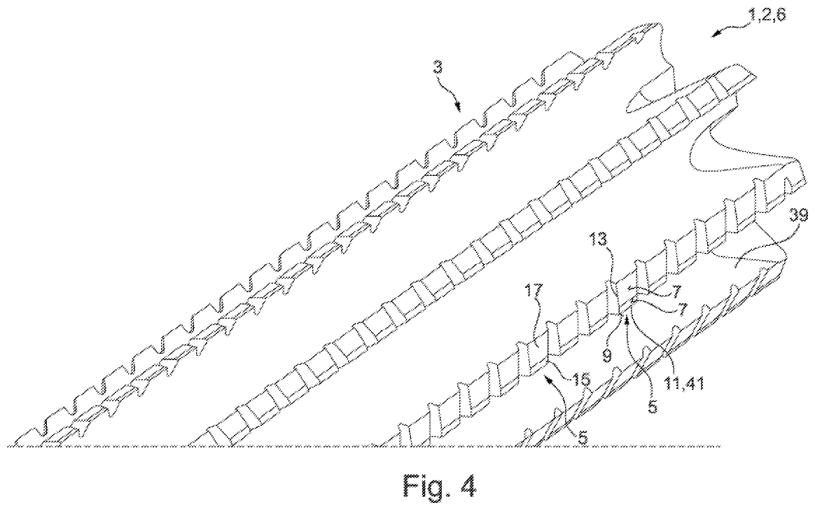

FIG. 4 is a perspective view of a second embodiment of a tool part 1. In this second embodiment, the tool part 1 is designed in the form of a cutting tool 2, in this case specifically a milling tool 6, in particular a milling cutter. As in the first embodiment, the tool part 1 is also set up in this case, in particular, for machining abrasive materials. The milling tool 6 has, in particular, a plurality of preferably identically designed cutting zones 5, for which, for the sake of better clarity, reference numbers are only provided in this case on two cutting zones 5 and divided between the cutting zones 5. The cutting edge 11 in the cutting zones 5 is in this case in particular a peripheral cutting blade 41 of the milling tool 6. Furthermore, FIG. 4 shows the main body 3, the clearance face 7, the position of the rake face 9, the arrangement of the coating 13, the clearance zone 15, and the coating zone 17. The milling tool 6 also has flutes 39, of which only one is marked with the corresponding reference number for the sake of better clarity. These flutes 39 are in this case in particular formed in a straight line.

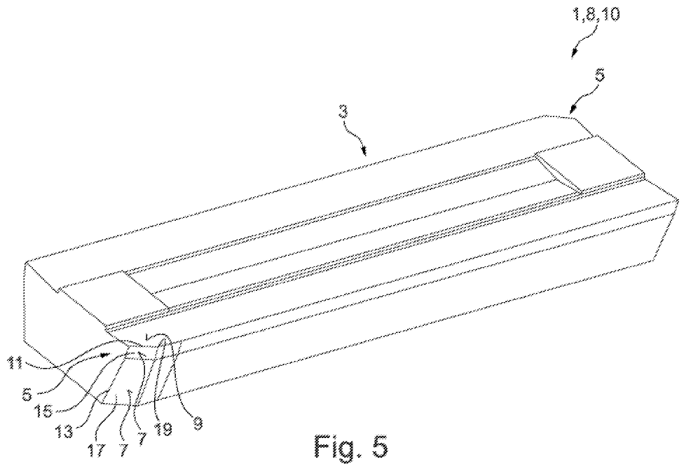

FIG. 5 is a perspective view of a third embodiment of a tool part 1. In this third embodiment, the tool part 1 is designed as a cutting plate 8, in particular as an indexable cutting plate 10, preferably having two cutting zones 5. In the same way as in the previous embodiments, the tool part 1 in this embodiment is also set up for machining abrasive materials. In FIG. 5, in particular the main body 3, the clearance face 7, the rake face 9, the cutting edge 11, the arrangement of the coating 13, the clearance zone 15, the coating zone 17, and also the cutting corner 19 can be clearly seen.

The tool part 1 is preferably produced, regardless of its specific embodiment, by providing the main body 3—in particular in the form of a hard metal rod or a hard metal plate—and by forming at least one cutting zone 5 on the main body 3. Subsequently, the cutting zone 5 is coated with the coating 13, in particular the hard material layer, in particular the diamond layer. Subsequently, the coating 13 is removed—preferably by means of a laser method—at least in certain zones on the clearance face 7 or from the clearance face 7, so that the clearance zone 15 is ultimately formed. It is also possible that the main body 3 is already provided with a finished cutting zone 5 so that only the coating 13 is applied and subsequently removed again from the clearance face 7 at least in certain zones. The provision of the intact main body 3 and the production of the at least one cutting zone 5 are therefore not necessarily part of the production method.

Prior to coating, a cutout 29 is preferably introduced into the clearance face 7 at a distance from the cutting edge 11. The coating 13 is then preferably only removed in the clearance zone 15 which is delimited on the one hand by the cutting edge 11 and on the other hand by the cutout 29. In this way, the cutout 29 ultimately defines the clearance zone 15.

1. A tool part (1) comprising a main body (3) and at least one cutting zone (5) formed on the main body (3), wherein the cutting zone (5) has a clearance face (7) and a rake face (9) which adjoin each other at a cutting edge (11), wherein the rake face (9) has a coating (13) applied to a main body material of the main body (3) and extending as far as the cutting edge (11), which coating is harder than the main body material, wherein the clearance face (7) is free of the coating (13) in a clearance zone (15) proceeding from the cutting edge (11).

2. The tool part (1) of claim 1, wherein the main body material is exposed in the clearance zone (15).

3. The tool part (1) of claim 1, wherein a coating zone (17) of the clearance face (7) adjoins the clearance zone (15) contrary to a cutting direction, in which coating zone the clearance face (7) has the coating (13).

4. The tool part (1) of claim 1, wherein the clearance zone (15) extends along the cutting edge (11) only over a clearance length (33) which is shorter than a cutting length of the cutting edge (11).

5. The tool part (1) of claim 1, wherein the tool part (1) is designed as a cutting tool (2), in particular as a drilling tool (4), in particular a drill, or as a milling tool (6), in particular for cutting abrasive materials, the cutting edge (11) preferably being a front cutting blade of the drill or a peripheral cutting blade (41) of the milling tool (6).

6. The tool part (1) according to claim 5, wherein the clearance zone (15), proceeding from a cutting corner (19) of the cutting edge (11), extends radially inward only along part of the cutting edge (11).

7. The tool part (1) of claim 5, wherein the cutting edge (11) has a central cutting blade (25) and a main cutting edge (23), the clearance zone (15) only extending along the main cutting blade (23), preferably only in certain zones along the main cutting blade (23).

8. The tool (1) of claim 1, wherein the tool part (1) is designed as a cutting plate (8), in particular as an indexable cutting plate (10).

9. A method for producing a tool part (1), comprising:
coating a cutting zone (5), which is formed on a main body (3) for the tool part (1) and has a clearance face (7) and a rake face (9) which adjoin each other at a cutting edge (11), with a coating (13) that is harder than a main body material of the main body (3), and
removing the coating (13) at least in certain zones on the clearance face (7).

10. The method of claim 9, wherein the coating (13) is removed by means of a laser method.

11. The method of claim 9, wherein the cutting zone (5) is produced on the main body (3) prior to coating.

12. The method of claim 9, wherein, prior to coating, a cutout (29) is introduced into the clearance face (7) at a distance from the cutting edge (11), the coating (13) preferably being removed only in a clearance zone (15) which is delimited on the one hand by the cutting edge (11) and on the other hand by the cutout (29).
